(19) United States
(12) Patent Application Publication
(10) Pub. No.: US 2015/0220891 A1
(43) Pub. Date: Aug. 6, 2015

(54) Method and Apparatus for Securely Distributing Digital Vouchers

(71) Applicant: SONY CORPORATION, Tokyo (JP)

(72) Inventor: David Karlsson, Lund (SE)

(21) Appl. No.: 14/366,591

(22) PCT Filed: Feb. 6, 2014
(86) PCT No.: PCT/IB2014/058841

§ 371 Date: Jun. 18, 2014

(51) Int. Cl. G06Q 20/04; G06F 21/10; G06Q 20/38; H04L 29/08

(52) U.S. Cl. CPC G06Q 20/0457; H04L 67/10; G06F 21/10; G06Q 20/3829; G06F 2221/0753

(57) ABSTRACT

A disclosed method is implemented by a voucher server for distributing digital vouchers. The voucher server stores a plurality of encrypted digital vouchers, each being encrypted with a respective one of a plurality of encryption keys and each having an associated identifier. The voucher server receives, from a computing device, a request for a digital voucher, the request including an identifier. The voucher server determines if the received identifier matches an identifier of any of the plurality of encrypted digital vouchers. If the received identifier matches an identifier for a given one of the encrypted digital vouchers, the voucher server transmits the given encrypted digital voucher to the computing device. The voucher server does not have access to the encryption key used to encrypt the given encrypted digital voucher.

### TECHNICAL FIELD

The present disclosure relates to digital vouchers, and in particular to a system for securely distributing encrypted digital vouchers.

### BACKGROUND

Digital vouchers may be used for a variety of different reasons, such as electronic gift cards, and are becoming increasingly popular for redeeming credit over the Internet. For example, a gaming network such as the PLAYSTATION Network may wish to provide digital vouchers to users for downloading additional games or game content. Similarly, digital vouchers may be used in music or video services (such as “Music Unlimited” and “Video Unlimited” from SONY) to obtain music and/or movies.

Distributing digital vouchers which can be redeemed to buy goods and/or services presents a number of security challenges. For example, one may want to provide a digital voucher to all the buyers of a certain class of devices (e.g., all purchasers of a SONY PLAYSTATION). To secure such a voucher distribution system, it may be desirable to make sure that only actual device owners get the vouchers, and that the vouchers are not stolen before device owners can use them. Adding to this challenge is the fact that voucher servers storing large quantities of vouchers are an attractive target for hackers, because a security breach could yield a large quantity of vouchers and a corresponding large amount of voucher credit.

### SUMMARY

According to one aspect of the present disclosure, a method is disclosed for distributing digital vouchers. The method is implemented by a voucher server. The voucher server stores a plurality of encrypted digital vouchers, each being encrypted with a respective one of a plurality of encryption keys and each having an associated identifier. The voucher server receives, from a computing device, a request for a digital voucher, with the request including an identifier. The voucher server determines if the received identifier matches an identifier of any of the plurality of encrypted digital vouchers. If the received identifier matches an identifier for a given one of the encrypted digital vouchers, the voucher server transmits the given encrypted digital voucher to the computing device. The voucher server does not have access to the plurality of encryption keys.

In one or more embodiments, each associated identifier is a computing device identifier, the received identifier is a unique, device-specific identifier that identifies only the computing device and does not identify other computing devices, and the device-specific identifier is the only computing device identifier that matches the given encrypted digital voucher.

According to another aspect of the present disclosure, a method is disclosed for redeeming a digital voucher. The method is implemented by a computing device. The computing device transmits an identifier to a voucher server, and, based on the transmitting, receives an encrypted digital voucher matching the identifier. The computing device decrypts the encrypted digital voucher using an encryption key stored in secure, limited-access memory of the computing device to obtain a decrypted digital voucher, and transmits the decrypted digital voucher to a redemption server to redeem the digital voucher. The voucher server does not have access to the encryption key.

In one or more embodiments, the decrypting of the encrypted digital voucher is performed by an application which is the only application on the computing device that is able to access the encryption key.

In one or more embodiments, the encryption key is a device-specific encryption key that is not accessible to other computing devices of the same type as the computing device. Optionally, the identifier may be a device-specific identifier that identifies only the computing device and does not identify other computing devices.

According to one aspect of the present disclosure, a voucher server operative to distribute digital vouchers is disclosed. The voucher server includes a memory circuit configured to store a plurality of encrypted digital vouchers, each being encrypted with a respective one of a plurality of encryption keys and each having an associated identifier. The voucher server also includes one or more processing circuits configured to receive, from a computing device, a request for a digital voucher, the request including an identifier. The one or more processing circuits are further configured to determine if the received identifier matches an identifier of any of the plurality of encrypted digital vouchers, and if the received identifier matches an identifier for a given one of the encrypted digital vouchers, transmit the given encrypted digital voucher to the computing device. The voucher server does not have access to the plurality of encryption keys.

In one or more embodiments, each associated identifier is a computing device identifier, the received identifier is a unique, device-specific identifier that identifies only the computing device and does not identify other computing devices, and the device-specific identifier is the only computing device identifier that matches the given encrypted digital voucher.

According to another aspect of the present disclosure, a computing device is operative to redeem a digital voucher. The computing device includes secure, limited-access memory, and also includes one or more processing circuits configured to transmit an identifier to a voucher server. The one or more processing circuits are further configured to, based on the transmission, receive an encrypted digital voucher matching the identifier. The one or more processing circuits are further configured to decrypt the encrypted digital voucher using an encryption key stored in the limited-access memory to obtain a decrypted digital voucher, and transmit the decrypted digital voucher to a redemption server to redeem the digital voucher. The voucher server does not have access to the encryption key.

In one or more embodiments, the decrypting of the encrypted digital voucher is performed by an application which is the only application on the computing device that is able to access the encryption key.

In one or more embodiments, the encryption key is a device-specific encryption key that is not accessible to other computing devices of the same type as the computing device. Optionally, the identifier may be a unique, device-specific identifier that identifies only the computing device and does not identify other computing devices.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates a system for securely distributing and redeeming digital vouchers.

FIG. 2 illustrates an example method implemented by a voucher server of distributing a digital voucher.

FIG. 3 illustrates an implementation of the method of FIG. 2.

FIG. 4 illustrates an example method implemented by a computing device of redeeming an encrypted digital voucher.

FIG. 5 illustrates an example voucher server operative to distribute a digital voucher.

FIG. 6 illustrates an example computing device operative to redeem a digital voucher.

### DETAILED DESCRIPTION

The present disclosure describes a system for securely distributing and redeeming encrypted digital vouchers. In one or more embodiments a voucher server stores a plurality of encrypted digital vouchers, each being encrypted with a respective one of a plurality of encryption keys, and each having an associated identifier (e.g., a mobile device identifier). However, the voucher server does not have access to any of the encryption keys. Therefore, if a security breach of the voucher server occurs, a hacker would likely be unable to decrypt and use any of the encrypted digital vouchers stored on the voucher server.

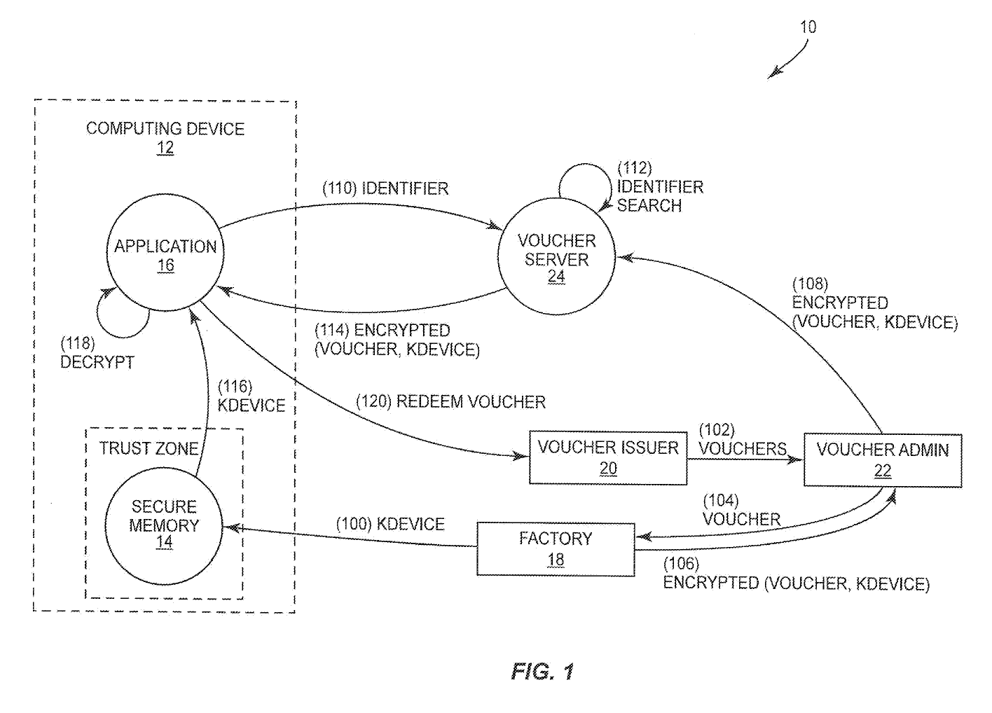

FIG. 1 illustrates a system 10 for securely distributing and redeeming digital vouchers according to one embodiment. The system 10 includes a plurality of computing devices 12 (one of which is shown in FIG. 1) that each include secure, limited-access memory 14. The set of computing device 12 are manufactured, and a respective encryption key is written into each of the devices (100). The encryption key is stored in the limited-access memory 14, which provides software and/or hardware protection (e.g., using the TRUSTZONE technology from ARM). In one or more embodiments, the encryption key is created based on an attribute of the computing device 12, such as an International Mobile Equipment Identity (IMEI) of the computing device 12, a serial number of the computing device 12, a version of software stored on the computing device 12, or a version of some hardware in the computing device 12. In one or more embodiments, the encryption key is a symmetric encryption key usable for symmetric encryption.

The limited-access memory 14 is accessible by a secure voucher application 16 on the computing device 10. In one or more embodiments, the application 16 is the only application on the computing device 12 that is able to access the encryption key. In one or more embodiments, the key is a device-specific key that is unique to the computing device 12. In the example of FIG. 1, the encryption key “Kdevice” is stored (100) in the limited-access memory 14 by an encryption server (shown as “factory” 18) during initial manufacture and/or configuration of the device (e.g., when device firmware is being installed). In one or more embodiments, a portion of the limited-access memory 14 used to store the encryption key is read-only memory that cannot be overwritten once the encryption key has been stored (100). In or more embodiments, this portion of the limited-access memory 14 is one-time programmable (OTP) memory.

A voucher issuing server (shown as “voucher issuer” 20) issues (102) a plurality of digital vouchers to a voucher administrative server (shown as “voucher administrator” 22). The voucher administrator 22 transmits (104) each of the digital vouchers to the factory 18 for encryption, and in return receives (106) encrypted digital vouchers that have been encrypted using respective ones of the plurality of encryption keys. For example, in one embodiment a digital voucher intended for a first computing device (CD₁) is encrypted with a device-specific encryption key for that computing device (Kdevice₁). Similarly, a digital voucher intended for a second computing device (CD₂) is encrypted with a device-specific encryption key for that computing device (Kdevice₂), and so on. In FIG. 1 a digital voucher encrypted with “Kdevice” is shown as “Encrypted (Voucher, Kdevice).” In one or more embodiments, each digital voucher is encrypted with a different device-specific encryption key.

Although FIG. 1 illustrates the “factory” server 18 as performing the encryption of the digital vouchers, it is understood that this could be performed by another node. For example, the voucher administrative server 22 may possess copies of the encryption keys stored on the various computing devices 12 and may perform the relevant encryption operations in 104 and 106.

Once the encrypted digital vouchers are obtained, the voucher administrator 22 provides (108) the encrypted digital vouchers to a voucher server 24. Once computing device 12 becomes aware that it is eligible for a digital voucher (or if it wants to check if it is eligible), the computing device transmits (110) a voucher request to the voucher server 24 that includes an identifier. The voucher server 24 receives the identifier and searches for a matching identifier in its memory (112). If a matching identifier is found, the voucher server 24 transmits (114) a corresponding encrypted digital voucher having an identifier that matches the received identifier. The computing device 12 receives the encrypted digital voucher, and the application 16 on the computing device 12 accesses (116) the encryption key stored in the secure memory 14, and decrypts (118) the encrypted digital voucher using the encryption key. Upon obtaining the unencrypted digital voucher, the computing device 12 redeems (120) the digital voucher with the voucher issuer 20.

Of course, it should also be noted that, in some alternative implementations, the actions noted may occur out of the order noted in the figures. For example, the voucher server 24 may receive a plurality of encrypted vouchers (shown as 108 in FIG. 1) before the encryption keys for those vouchers are actually stored on computing devices 12 (shown as 100 in FIG. 1). The computing device 12 may be a cellular telephone, smartphone, personal digital assistant (PDA), media player, tablet computer, laptop computer, laptop embedded equipment (LEE), laptop mounted equipment (LME), a gaming console, or any other device equipped with capabilities for decryption, and for wired or wireless communication.

In one or more embodiments, each identifier is a computing device identifier, and optionally is a unique, device-specific identifier that identifies only the computing device in question and does not identify other computing devices. Some example device-specific identifiers include an International Mobile Equipment Identity (IMEI) or a Media Access Control (MAC) address, or some other device-specific hardware identifier. Thus, in some embodiments the computing device 12 is a WiFi or Ethernet computing device 12, and uses WiFi or Ethernet to perform the communications of 110, 114, and 116. In other embodiments, the computing device identifier is not device specific, and instead refers to a class of devices. In such embodiments, the identifier may include (or be based on) a model name, a software version, etc. of a class of devices (e.g., an identifier identifying a plurality of tablet computing devices having a certain firmware version).

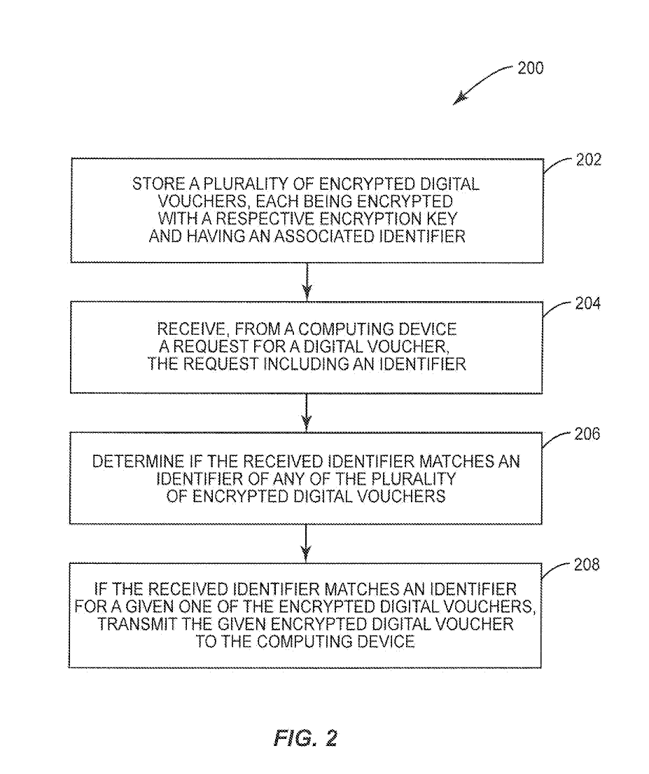

FIG. 2 illustrates a method 200 implemented by the voucher server 24 of distributing encrypted digital vouchers. The voucher server 24 stores a plurality of encrypted digital vouchers, each being encrypted with a respective one of a plurality of encryption keys and each having an associated identifier (block 202). The voucher server 24 receives, from computing device 12, a request for a digital voucher, with the request including an identifier (block 204). The voucher server 24 determines if the received identifier matches an identifier of any of the plurality of encrypted digital vouchers (block 206). If the received identifier matches an identifier for a given one of the encrypted digital vouchers, the voucher server transmits the given encrypted digital voucher to the computing device 12 (block 208). Notably, the voucher server 24 does not store a copy of the encryption key used to encrypt the given encrypted digital voucher, and also does not have access to the encryption key.

In one or more embodiments the identifier “matching” a stored identifier in the voucher server 24 comprises the identifiers being the same. In one or more other embodiments, the identifier “matching” a stored identifier in the voucher server 24 comprises a mapping (e.g., a table or a mapping function) on the voucher server 24 indicating that the received identifier maps to the stored identifier on the voucher server 24.

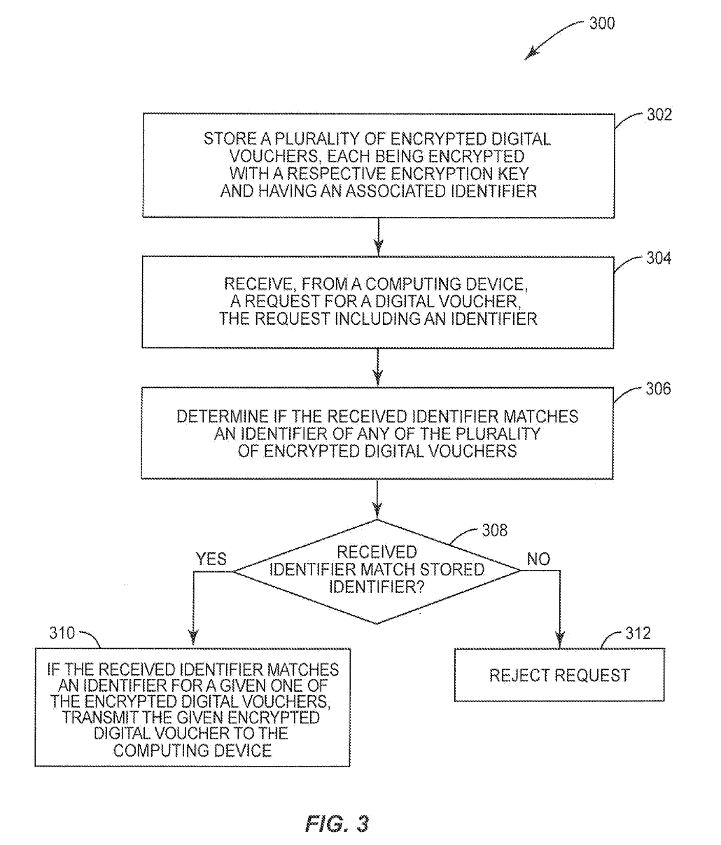

FIG. 3 illustrates an implementation 300 of the method of FIG. 2. In the embodiment of FIG. 3, blocks 302, 304, 306, and 310 are the same as blocks 202, 204, 206, and 208 of FIG. 2. However, FIG. 3 also includes blocks 308, 312. In block 308, a determination is made of whether the received identifier matches any of the stored identifiers, and if the received identifier does not match any of the stored identifiers the request is rejected (block 312).

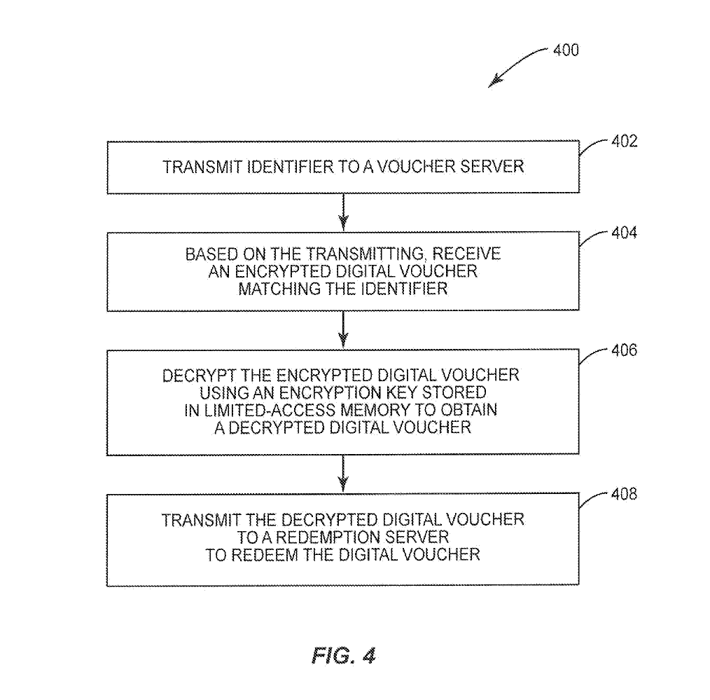

FIG. 4 illustrates an example method 400 implemented by the computing device 12 of redeeming an encrypted digital voucher. The computing device 12 transmits an identifier, such as an IMEI, to the voucher server 24 (block 402). Based on the transmitting, the computing device 12 receives an encrypted digital voucher matching the identifier (block 404). The computing device 12 decrypts the encrypted digital voucher using an encryption key stored in secure, limited-access memory of the computing device 12 to obtain a decrypted digital voucher (block 406). The computing device 12 transmits the decrypted digital voucher to a redemption server (e.g., voucher issuer 16) to redeem the digital voucher (block 408). The voucher server 24 does not have access to the encryption key.

In one or more embodiments, the decrypting of block 406 is performed by application 16, and the application 16 is the only application on the computing device 12 that is able to access the encryption key. As discussed above, the encryption key may be a device-specific encryption key that is not accessible to other computing devices of the same type as the computing device 12. Also, the transmitted identifier may be a unique, device-specific identifier (e.g., an IMEI) that identifies the computing device 12 and does not identify other computing devices.

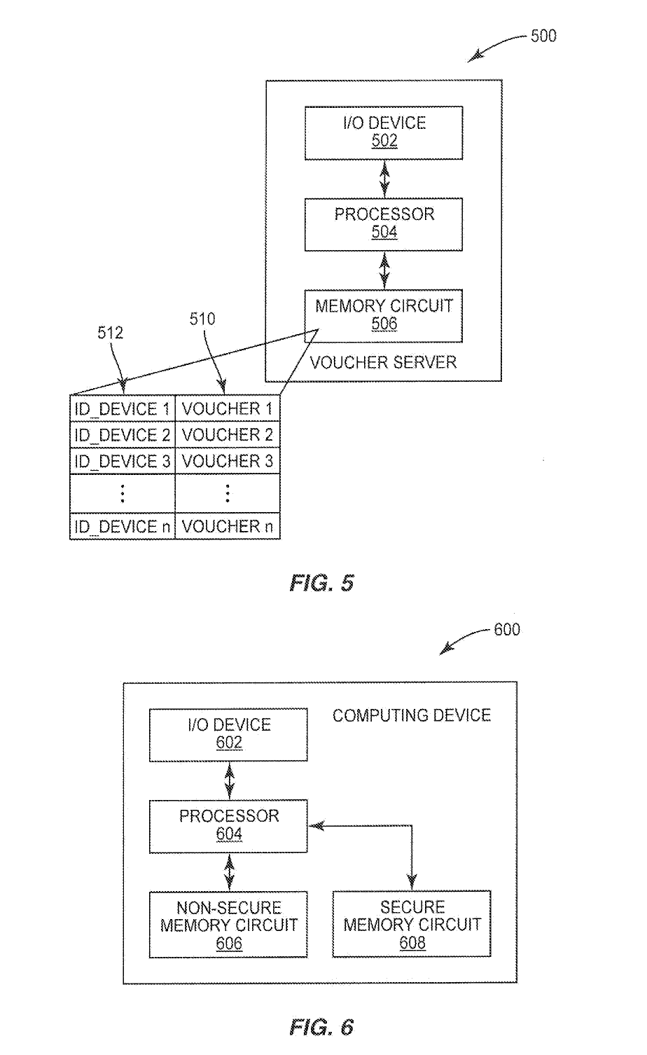

FIG. 5 illustrates an example voucher server 500 that is operative to distribute digital vouchers and may be used as the voucher server 24 of FIG. 1. The voucher server 500 includes an input/output (I/O) device 502 configured to communicate with other devices (e.g., computing device 12 and voucher administrator 22). In one or more embodiments, the I/O device is a WiFi or Ethernet-based transceiver configured to communicate using one or more 802.11 standards. The voucher server 500 also includes a memory circuit 506 that includes one or several types of memory such as read-only memory (ROM), random-access memory, cache memory, flash memory devices, optical storage devices, etc. The memory circuit 506 is configured to store a plurality of encrypted digital vouchers 510, each being encrypted with a respective one of a plurality of encryption keys and each having an associated identifier 512. The voucher server 500 also includes a processor 504 that includes one or more processor circuits, including, for example, one or more microprocessors, microcontrollers, or the like, configured with appropriate software and/or firmware to carry out one or more of the techniques discussed above.

In particular, the processor 504 is configured to receive, from a computing device 12, a request for a digital voucher, the request including an identifier. The processor 504 is also configured to determine if the received identifier matches an identifier 512 of any of the plurality of encrypted digital vouchers 510. If the received identifier matches an identifier for a given one of the encrypted digital vouchers 510, the processor 504 transmits the given encrypted digital voucher to the computing device 12. If the received identifier does not match an identifier 512 of any of the encrypted digital vouchers 510, the processor 504 rejects the request. The plurality of encryption keys are not stored on the voucher server 500 and are not accessible by the voucher server 500. Thus, in the event that the voucher server 500 is breached, it is highly unlikely that a malicious user would be able to decrypt the encrypted digital vouchers stored in the memory circuit 506.

FIG. 6 illustrates an example computing device 600 that may be used as the computing device 12 of FIG. 1. The computing device 600 includes an input/output (I/O) device 602 configured to communicate with other devices (e.g., voucher server 24 and voucher issuer 20). The I/O device may include a wireless transceiver configured according to one or more 3GPP and/or 802.11 wireless communication standards. The computing device 600 includes non-secure memory circuit 606 and a secure, limited-access memory circuit 608, each of which includes one or several types of memory such as read-only memory (ROM), random-access memory, cache memory, flash memory devices, optical storage devices, etc. The non-secure memory circuit 606 stores an identifier of the computing device (e.g., an IMEI or MAC address). The secure memory circuit 608 stores an encryption key (e.g. a device-specific encryption key). In one or more embodiments, the limited-access memory circuit 608 is accessible only by a single application (e.g., secure voucher application 16 from FIG. 1) that executes from the non-secure memory circuit 606).

The computing device 600 includes a processor 604 that includes one or more processor circuits, including, for example, one or more microprocessors, microcontrollers, or the like, that are configured with appropriate software and/or firmware to carry out one or more of the techniques discussed above. In particular, the processor 604 is configured to transmit the identifier to voucher server 24, and based on that transmission, receive an encrypted digital voucher matching the identifier. The processor 604 is further configured to decrypt the encrypted digital voucher using the encryption key stored in the limited-access memory circuit 608 to obtain a decrypted digital voucher. The processor 604 is configured to transmit the decrypted digital voucher to a redemption server (e.g., voucher issuer 20 in FIG. 1) to redeem the digital voucher. Notably, the voucher server 24 does not have access to the encryption key.

As a non-limiting example, secure memory circuit 608 may be configured at least in part according to the ARM TRUSTZONE specifications to provide a secure processing domain for storing the encryption key. In this regard, the processor 604 may have a “secure domain” (utilizing secure memory circuit 608) and a “non-secure domain” (utilizing non-secure memory circuit 606). In one or more embodiments, the portion of the secure memory circuit 608 used to store the encryption key is read-only memory that cannot be overwritten once the encryption key has been saved. In or more embodiments, this portion of the secure memory circuit 608 is one-time programmable (OTP) memory.

Referring again to FIG. 1, the factory 18, voucher issuer 20, voucher administrative server 22, and voucher server 24 are shown as all being separate servers. However, some of these items can be combined, as long as the voucher server 24 is still unable to access the relevant encryption key(s). For example, the voucher issuer 20, voucher admin 22, and voucher server 24 may all correspond to a single server in one embodiment. However, in other embodiments these correspond to one or more separate entities.

Some example uses for the techniques described above include distributing credits for the PLAYSTATION network to a group of PLAYSTATION console owners. For example, a digital voucher could be issued to each console owners who purchased their console during a certain time period. Alternatively, a digital voucher could be issued to each console owner that owns a particular game. Of course this is just a non-limiting embodiment, and many other computing devices 12 could be used other than gaming consoles, and many other applications of the techniques described above would be possible.

An advantage of the techniques described above is that the vouchers stored on the voucher server 24 are encrypted with encryption keys that the voucher server 24 does not have access to (e.g., the keys may exist only on the computing devices 12 and the factory server 18). This means that it is not meaningful to attack the voucher server 24, even though it contains all the encrypted digital vouchers. In such embodiments, to steal and redeem the stored encrypted digital vouchers, a malicious user would have to attack the computing devices 12 one by one to obtain the relevant encryption keys to decrypt their stolen encrypted digital vouchers. Thus, the system 10 is not very attractive to attack.

The actual encryption keys can be thrown away or deleted, or optionally or kept on a separate server (e.g., factory server 18), for example. Optionally, the separate server storing the encryption keys may be disconnected from the Internet and/or other networks. This can avoid the problem of having an Internet-connected voucher server that stores the encryption keys of the computing devices 12 to provide further security.

The present disclosure may, of course, be carried out in other ways than those specifically set forth herein without departing from essential characteristics of the present disclosure. The present embodiments are to be considered in all respects as illustrative and not restrictive, and all changes coming within the meaning and equivalency range of the appended claims are intended to be embraced therein.

1-14. (canceled)

15. A method implemented by a voucher server of distributing digital vouchers, the method comprising:
storing a plurality of encrypted digital vouchers, each being encrypted with a respective one of a plurality of encryption keys and each having an associated identifier;
receiving, from a computing device, a request for a digital voucher, the request including an identifier;
determining if the received identifier matches an identifier of any of the plurality of encrypted digital vouchers; and
if the received identifier matches an identifier for a given one of the encrypted digital vouchers, transmitting the given encrypted digital voucher to the computing device;
wherein the voucher server does not have access to the plurality of encryption keys.

16. The method of claim 15, further comprising rejecting the request if the received identifier does not match an identifier of any of the encrypted digital vouchers.

17. The method of claim 15:
wherein each associated identifier is a computing device identifier;
wherein the received identifier is a unique, device-specific identifier that identifies only the computing device and does not identify other computing devices; and
wherein the device-specific identifier is the only computing device identifier that matches the given encrypted digital voucher.

18. A method implemented by a computing device of redeeming a digital voucher, the method comprising:
transmitting an identifier to a voucher server;
based on the transmitting, receiving an encrypted digital voucher matching the identifier;
decrypting the encrypted digital voucher using an encryption key stored in secure, limited-access memory of the computing device to obtain a decrypted digital voucher; and
transmitting the decrypted digital voucher to a redemption server to redeem the digital voucher;
wherein the voucher server does not have access to the encryption key.

19. The method of claim 18, wherein said decrypting the encrypted digital voucher is performed by an application which is the only application on the computing device that is able to access the encryption key.

20. The method of claim 18, wherein the encryption key is a device-specific encryption key that is not accessible to other computing devices of the same type as the computing device.

21. The method of claim 18, wherein the identifier is a unique, device-specific identifier that identifies only the computing device and does not identify other computing devices.

22. A voucher server operative to distribute digital vouchers, the voucher server comprising:
a memory circuit configured to store a plurality of encrypted digital vouchers, each being encrypted with a respective one of a plurality of encryption keys and each having an associated identifier; and
one or more processing circuits configured to:
receive, from a computing device, a request for a digital voucher, the request including an identifier;
determine if the received identifier matches an identifier of any of the plurality of encrypted digital vouchers; and
if the received identifier matches an identifier for a given one of the encrypted digital vouchers, transmit the given encrypted digital voucher to the computing device;
wherein the voucher server does not have access to the plurality of encryption keys.

23. The voucher server of claim 22, wherein the one or more processing circuits are further configured to reject the request if the received identifier does not match an identifier of any of the encrypted digital vouchers.

24. The voucher server of claim 22:
wherein each associated identifier is a computing device identifier;
wherein the received identifier is a unique, device-specific identifier that identifies only the computing device and does not identify other computing devices; and
wherein the device-specific identifier is the only computing device identifier that matches the given encrypted digital voucher.

25. A computing device operative to redeem a digital voucher, the computing device comprising:
secure, limited-access memory; and
one or more processing circuits configured to:
transmit an identifier to a voucher server;
based on the transmission, receive an encrypted digital voucher matching the identifier;
decrypt the encrypted digital voucher using an encryption key stored in the limited-access memory to obtain a decrypted digital voucher; and
transmit the decrypted digital voucher to a redemption server to redeem the digital voucher;
wherein the voucher server does not have access to the encryption key.

26. The method of claim 25, wherein to decrypt the encrypted digital voucher, the one or more processing circuits are configured to utilize a software application which is the only application on the computing device that is able to access the encryption key.

27. The method of claim 25, wherein the encryption key is a device-specific encryption key that is not accessible to other computing devices of the same type as the computing device.

28. The method of claim 25, wherein the identifier is a unique, device-specific identifier that identifies only the computing device and does not identify other computing devices.
